(19) United States
(12) Patent Application Publication
(10) Pub. No.: US 2024/0303667 A1
(43) Pub. Date: Sep. 12, 2024

(54) SYSTEM AND METHOD FOR ENABLING DATA ACCESS IN A VIRTUAL ENVIRONMENT

(71) Applicant: The Toronto-Dominion Bank, Toronto (CA)

(72) Inventors: Tonja Selena LAUNEN, Toronto (CA); James Frederick FLOYD, Toronto (CA); Paul Thomas MCGHEE, Burlington (CA); Andy Jason LY, Morriston (CA); Stephen Matthew DEARDEN, Toronto (CA)

(21) Appl. No.: 18/179,708

(22) Filed: Mar. 7, 2023

(51) Int. Cl. G06Q 30/015; G06F 3/01

(52) U.S. Cl. CPC G06Q 30/015; G06F 3/011

(57) ABSTRACT

Computing platforms, methods, and storage media for enabling data access in a virtual environment are disclosed. Exemplary implementations may: obtain, from a data server, data associated with a plurality of customer records, such as customer accounts; generate, by a processor, a plurality of display components configured to display, in a virtual three-dimensional environment, customer record details associated with the plurality of customer records; and provide the plurality of display components for display in the three-dimensional virtual environment such that the plurality of display components are viewable in the three-dimensional environment by a user associated with the customer record details and by a third party. Exemplary implementations may provide enhanced access to customer records or customer accounts, including forecasting and visualization, for example in a metaverse environment.

### FIELD

The present disclosure relates to data access, including but not limited to computing platforms, methods, and storage media for enabling data access in a virtual environment.

### BACKGROUND

Users often need to access and view a number of different user records, for example customer records or details.

Widgets and dashboards may be used to provide information to users. However, existing portals are limited with respect to the amount of information that can concurrently be displayed.

Improvements in approaches for enabling data access in a virtual environment are desirable.

### BRIEF DESCRIPTION OF THE DRAWINGS

Embodiments of the present disclosure will now be described, by way of example only, with reference to the attached Figures.

FIG. 1 illustrates a system configured for enabling data access in a virtual environment, in accordance with one or more embodiments.

FIG. 2 illustrates another system configured for enabling data access in a virtual environment, in accordance with one or more embodiments.

FIG. 3 illustrates a method for enabling data access in a virtual environment, in accordance with one or more embodiments.

FIG. 4 illustrates an example of a display illustrating data access in a virtual environment, in accordance with one or more embodiments.

### DETAILED DESCRIPTION

Computing platforms, methods, and storage media for enabling data access in a virtual environment are disclosed. Exemplary implementations may: obtain, from a data server, data associated with a plurality of customer records, such as customer accounts; generate, by a processor, a plurality of display components configured to display, in a virtual three-dimensional environment, customer record details associated with the plurality of customer records; and provide the plurality of display components for display in the three-dimensional virtual environment such that the plurality of display components are viewable in the three-dimensional environment by a user associated with the customer record details and by a third party.

The present disclosure provides a system and method for accessing data in a virtual environment, for example in the metaverse. The present disclosure may provide, in the metaverse, a commercial banking experience with enhanced access to customer records or customer data, for example including commercial banking data, forecasting and visualization.

In an example embodiment, the present disclosure provides a tool that leverages metaverse technology, and provides an improvement on dashboards and widgets for commercial banking customers. Embodiments of the present disclosure may provide a holistic approach to displaying a large amount of information in a new way in the metaverse, while providing the ability to engage with a third party, such as an advisor, in the metaverse. When engaging with an advisor in the metaverse, the system may be configured so that the user and the advisor may both see the same information.

One aspect of the present disclosure relates to a computing platform configured for enabling data access in a virtual environment. The computing platform may include a non-transient computer-readable storage medium having executable instructions embodied thereon. The computing platform may include one or more hardware processors configured to execute the instructions. The processor(s) may execute the instructions to obtain, from a data server, data associated with a plurality of customer records. The processor(s) may execute the instructions to generate, by a processor, a plurality of display components configured to display, in a virtual three-dimensional environment, customer record details associated with the plurality of customer records. The processor(s) may execute the instructions to provide the plurality of display components for display in the three-dimensional virtual environment such that the plurality of display components is viewable in the three-dimensional environment by a user associated with the customer record details and by a third party.

Another aspect of the present disclosure relates to a method for enabling data access in a virtual environment. The method may include obtaining, from a data server, data associated with a plurality of customer records. The method may include generating, by a processor, a plurality of display components configured to display, in a virtual three-dimensional environment, customer record details associated with the plurality of customer records. The method may include providing the plurality of display components for display in the three-dimensional virtual environment such that the plurality of display components is viewable in the three-dimensional environment by a user associated with the customer record details and by a third party.

Yet another aspect of the present disclosure relates to a non-transient computer-readable storage medium having instructions embodied thereon, the instructions being executable by one or more processors to perform a method for enabling data access in a virtual environment. The method may include obtaining, from a data server, data associated with a plurality of customer records. The method may include generating, by a processor, a plurality of display components configured to display, in a virtual three-dimensional environment, customer record details associated with the plurality of customer records. The method may include providing the plurality of display components for display in the three-dimensional virtual environment such that the plurality of display components is viewable in the three-dimensional environment by a user associated with the customer record details and by a third party.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

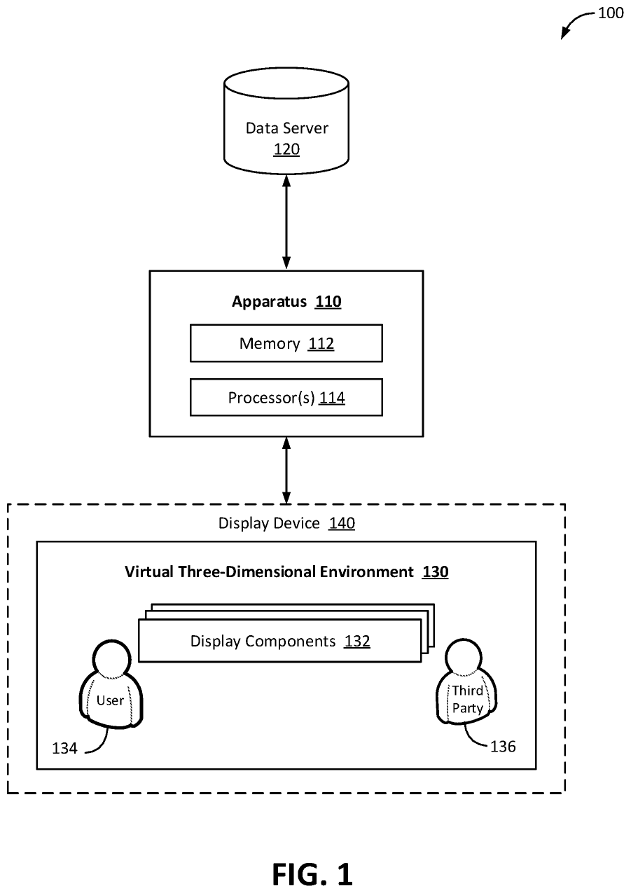

FIG. 1 illustrates a system 100 configured for enabling data access in a virtual environment, in accordance with one or more embodiments. The system comprises an apparatus 110, a data server 120, and a virtual three-dimensional environment 130.

The apparatus 110 may be configured for enabling data access in the virtual environment 130. The apparatus may comprise a non-transient computer-readable storage medium 112 having executable instructions embodied thereon, and one or more hardware processors 114. The processor(s) 114 may be configured to execute the instructions to obtain, from the data server 120, data associated with a plurality of customer records. The plurality of customer records may comprise a plurality of customer accounts.

In an example embodiment, the plurality of customer accounts may comprise a plurality of commercial accounts, such as commercial banking accounts, to which a company's chief financial officer or payment coordinator may have access. The plurality of customer accounts may be linked to a master account, such as a corporate banking account. The master account may be associated with a plurality of user access accounts providing different levels of access associated with the respective user access account. For example, the different levels of access may be based on a role of a user associated with a user access account.

The processor(s) 114 may be configured to execute the instructions to generate, by processor(s) 114, a plurality of display components 132 configured to display, in the virtual three-dimensional environment 130, customer record details associated with the plurality of customer records. The customer record details may provide further information relating to one or more of the plurality of customer records. For example, for a customer record associated with a lending account, the customer record details may comprise one or more of loan amount, loan term, loan borrowing rate, loan repayment parameters.

The processor(s) 114 may be configured to execute the instructions to provide the plurality of display components for display in the three-dimensional virtual environment such that the plurality of display components 132 are viewable in the three-dimensional environment 130. The plurality of display components may be viewable in the three-dimensional environment 130 on a display device 140, for example by a user 134 associated with the customer record details, and by a third party 136.

The plurality of display components 132 may have associated therewith user access rights parameters and third party access rights parameters. The processor(s) 114 may be configured to display the plurality of display components 132 in the three-dimensional virtual environment 130 based on the user access rights parameters and on the third party access rights parameters. The user access rights parameters and the third party access rights parameters may vary or differ from one display component to another, so that the processor(s) 114 may be configured to permit display to both the user and the third party, or to selectively permit display to the user and/or the third party. The user access rights permissions may be based on a user's ownership of, or association with, the plurality of customer records related to the plurality of display components. The third party access rights permissions may be based on a third party's assigned role with respect to the user, for example as an advisor or agent who has been granted access permission to view the plurality of customer records related to the plurality of display components.

A display device 140 may be configured to display the virtual three-dimensional environment 130. In an embodiment, a first display device may be associated with a user, and a second display device may be associated with a third party. The display device may be a virtual reality headset, or other display device configured to enable an immersive experience in the virtual three-dimensional environment 130. The device 140 may display or provide a perspective of the view of a user or third party of the virtual three-dimensional environment 130. For example, a first display device may provide the user 134 with a first perspective of the virtual three-dimensional environment 130 from the point of view of the user 134. A second display device may provide the third party 136 with a second perspective of the virtual three-dimensional environment 130 from the point of view of the third party 136.

In an example embodiment, the data server 120 comprises a financial institution data server, the plurality of customer records is associated with a customer account, the user comprises a customer associated with the plurality of customer records, and the three-dimensional virtual environment comprises the metaverse. Embodiments of the present disclosure leverage the metaverse, including virtual reality (VR) and augmented reality (AR) aspects, to provide an enhanced user experience, such as an enhanced commercial banking experience.

Instead of creating widgets for a two-dimensional dashboard, embodiments of the present disclosure may set up a type of dashboard experience in the metaverse so that a user can see all of their customer records at once, for example all of their commercial banking information. Embodiments of the present disclosure are configured to display information in a new and more holistic way than current two-dimensional approaches and their limitations.

In an implementation, a commercial banking user may enter the virtual three-dimensional environment 130, such as a metaverse environment, and is able to navigate or “walk” through the metaverse environment, in which a plurality of display elements 132 in the metaverse are configured to display details relating to one or more accounts or customer records. The virtual three-dimensional environment 130 may be configured by the apparatus 110 to display a plurality of types of data, including data that is reflective of what the user currently has access to in an existing commercial banking portal, for example based on stored user permissions. Such information may include loans, payments, accounts, making payments, transferring money, management of team.

In an example implementation, a user may be a commercial banking user. Commercial banking users may include chief financial officers (CFOs), or other users or people who are taking care of or are responsible for payments. In a commercial banking portal, different groups may be set up, and where the different groups are configured to see different views of the information. For example, the commercial banking user may be associated with a company and may have associated therewith a plurality of user profiles including a first user profile and a second user profile. The first user profile may have access to only non-sensitive company records. The second user profile may have access to all company records, including sensitive data.

Embodiments of the present disclosure may provide the plurality of display components 132 based on stored user permissions used by the data server 120 to manage or regulate data access. For example, user permissions may be stored in the data server 120, or in a non-transitory memory associated with the data server 120, to manage or regulate data access for one or more users, or user groups, associated with the plurality of customer records. These stored user permissions may advantageously be leveraged to determine the manner in which the plurality of display components 132 are displayed or made available to different users, even when those different users are part of a user group associated with the same customer records.

While an example embodiment is described with respect to commercial banking, embodiments of the present disclosure may be applied to other use cases, such as personal banking. Embodiments of the present disclosure may also relate to other scenarios in which a user or customer desires to access a set of information relating to one or more records or accounts, the details of which would not typically be able to be displayed concurrently, for example because of technical or visual real estate limitations.

The virtual three-dimensional environment 130 expands on the idea of two-dimensional space and environment. Embodiments of the present disclosure may be configured to forecast and engage with information in one area of customer records and see the effect in another area of a user's customer records that make up part of a user portfolio. Embodiments of the present disclosure may leverage metaverse technology to display user account data in a new environmental experience.

In a known two-dimensional experience, a user would have to open a dashboard a number of different times, and the different views would not be connected. According to one or more embodiments, a plurality of different views and pieces of account information may be connected and may be concurrently displayed. It is no longer necessary to have a dashboard, since the experience is not limited by two-dimensional screen size, either in a virtual environment or in relation to physical screen sizes. Embodiments of present disclosure may present to a user all of the information holistically, so that the user can view it experientially in the virtual three-dimensional environment 130, such as the metaverse.

Some embodiments provide have different areas in the three-dimensional virtual environment 130 dedicated to different types of customer records. For example, a first set of display components may be configured to display a first set of data, such as loan data, and a second set of display components may be configured to display a second set of data, for example transaction or payment data. The first and second sets of display components may be provided such that they are concurrently viewable in a user's perspective of the three-dimensional virtual environment 130. The first and second sets of display components may be provided such that the first set of display components is fully visible from a current user perspective of the three-dimensional virtual environment 130, and the second set of display components is at least partially visible.

In an example embodiment, the present disclosure provides the ability for a user to connect with a third party 136, such as an advisor, for example to connect and discuss the displayed information. In an implementation, the user 134 and the third party 136 share the same view of what the user is seeing in the metaverse, which enables enhanced interaction and communication. In an implementation, the user 134 and the third party 136 have slightly different perspectives of the same display components 132, which enables enhanced interaction and communication.

In a metaverse experience of the present disclosure, a user 134 may view the information including the display components 132, and interact or converse with the third party 136 in the metaverse while both the user 134 and the third party 136 are looking at the same information, for example each from their own perspective. The apparatus 110 is configured to enable the third party 136 to work with the user 134 in the same virtual environment 130 in the same format. This provides a novel approach to visual representation and sharing of information. The third party 136 may be an advisor, and may appear as an avatar, or as a video call provided within the environment, or any other suitable means. For example, an advisor representation may be provided in the three-dimensional virtual environment 130 by interfacing the three-dimensional virtual environment 130 with a video communications application, such as Zoom™ or Microsoft™ Teams. In another example, an advisor representation may be provided as an advisor avatar in the three-dimensional virtual environment 130.

In an example embodiment, the user 134 and the third party 136 have access to the same three-dimensional virtual environment 130 and may see the same account information for the user. In another example embodiment, the user 134 and the third party 136 are in the same three-dimensional virtual environment 130 and may see each other as well as the same account information for the user. In an embodiment, the apparatus 110 may be configured to enable the user 134 to interact in the metaverse and make certain changes without needing to interact with a third party. In an example embodiment, the user 134 may have access to a user view of the three-dimensional virtual environment 130 in which the user may not appear, as the view is a first-person view from the user's perspective.

In an example embodiment, the third party 136 may have access to a third party view of the three-dimensional virtual environment 130 in which the third party may not appear, as the view is a first-person view from the third party's perspective. In an example implementation, the third party view of the three-dimensional virtual environment 130 may differ from the user view of the three-dimensional virtual environment 130 For example, in an implementation in which the third party 136 is an advisor or relationship manager, the third party 136 may see slightly different data on their display than the user, for example internal third party data that is not visible to the customer. In an exemplary financial services implementation, the internal third party data may comprise financial or banking data that a financial institution stores with respect to the user, and which is not typically provided to the user in either an in-person or electronic interaction with the user.

In an example embodiment of the present disclosure, the apparatus 110 may cooperate with the data server 120 and the three-dimensional virtual environment 130 to provide different forecasting capabilities. For example, the system may provide display components to help a user to visualize the answer to a question such as: “What is my financial outlook and position in 6 months if I engage with a particular loan?” This may be achieved by the processor(s) 114 being configured to, for example: provide a first set of display components based on current client records; calculate forecasted data based on the current client records and based on one or more forecasting criteria; generate a second set of display components based on the forecasted data. The first and second sets of display components may be concurrently displayed in the three-dimensional virtual environment 130 to enable the user and the third party to compare the current records and the modified records based on the forecasted data. This may be repeated for a plurality of different scenarios, so that a plurality of different scenario forecasts may be concurrently displayed for comparison with each other and with the current records.

Embodiments of the present disclosure may overcome limitations of known two-dimensional display arrangements, for example by taking a graph based on user account information, and creating a forecast to show which data may change in different areas, based on one or more changed parameters or criteria. This is in contrast to known approaches, where forecasting is limited in what a user can see on one screen, or on a limited number of screens.

Embodiments of the present disclosure may leverage an API to connect to user records, such as a user's account data. Using such an API, the apparatus 110 and the data server 120 may cooperate to display, in the virtual three-dimensional environment 130 and preferably after user authentication, display components 132 based on real account data, or customer records based on real-time or near-real-time data. Embodiments of the present disclosure may further use these pillars of data connection, and provide a user experience, for example around commercial banking, in which both customers and third parties benefit.

In an implementation, the virtual three-dimensional environment 130 may display a visual environment that is associated with a preferred or pleasant experience for the user. For example, if the user has indicated, in their customer records, a preference for the outdoors, the virtual three-dimensional environment 130 may be configured to provide the display components 132 on a display background of an outdoor setting, such as parkland or a golf course, base don the stored customer records. The user records, such as customer financial information, may be displayed in the context of that setting, rather than with a background of a bank building or other display format that is not tailored to the user.

The apparatus 110 may cooperate with the data server 120 and/or a display device 140 to improve functioning of a processor displaying, or associated with display of, the virtual three-dimensional environment 130, by making the processor more efficient. For example, the apparatus may cooperate with the data server 120 and the display device 140 to selectively provide a plurality of display components to both a user associated with the customer records and to a third party authorized to access the customer records. The apparatus 110 may cooperate with the data server 120 and the display device 140 to display the plurality of display components such that they are viewable in the three-dimensional virtual environment by a user associated with the customer record details, and by a third party authorized to view the customer record details. The apparatus 110 may cooperate with the data server 120 and the display device 140 to concurrently display the plurality of display components such that they are concurrently viewable in the three-dimensional virtual environment by a user associated with the customer record details, and by a third party authorized to view the customer record details.

Such cooperation between the apparatus 110, the data server 120 and the display device 140 may impart selective provision of the plurality of display components to the user and to the third party, reducing the processor load and cost compared to existing approaches, as well as reducing the memory required. Embodiments of the present disclosure may provide a technical improvement by configuring a display device 140, for example a virtual reality headset, to display, and preferably concurrently display, the plurality of display components 132 in the virtual three-dimensional environment 130. This use of a display device displaying a virtual three-dimensional environment provides improvements in processor efficiency, memory efficiency and reduces the use of display resources compared to attempting to use a plurality of physical display screens to each display different dashboards or other visual representations of the customer records. This solves a computing display problem by providing a solution that reduces the number of physical display devices required, and provides improved display capabilities in a virtual three-dimensional environment, while improving user experience and reducing resource costs associated with the display. Such improvements and solutions to computer problems are also achieved by methods of one or more embodiments described and illustrated herein.

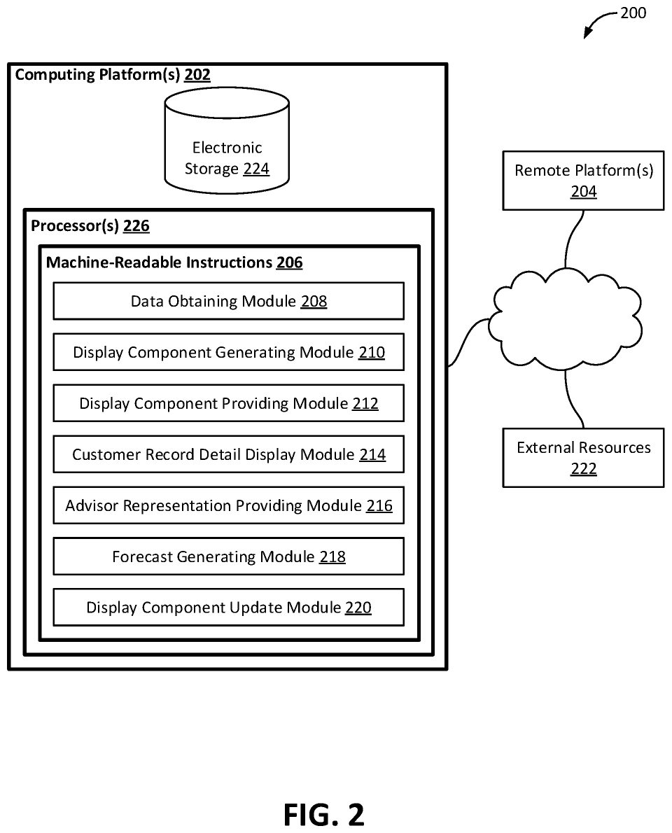

FIG. 2 illustrates another system 200 configured for enabling data access in a virtual environment, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of data obtaining module 208, display component generating module 210, display component providing module 212, customer record detail display module 214, advisor representation providing module 216, forecast generating module 218, display component update module 220, and/or other instruction modules.

Data obtaining module 208 may be configured to obtain, from a data server, data associated with a plurality of customer records. The plurality of customer records may be associated with a customer account. The plurality of customer records may include a plurality of commercial accounts. The data server may include a financial institution data server.

Display component generating module 210 may be configured to generate, by a processor, a plurality of display components configured to display, in a virtual three-dimensional environment, customer record details associated with the plurality of customer records.

Display component providing module 212 may be configured to provide the plurality of display components for display in the three-dimensional virtual environment such that the plurality of display components is viewable in the three-dimensional environment by a user associated with the customer record details and by a third party. The user may include a customer associated with the plurality of customer records. The third party may include an advisor. Display component providing module 212 may be configured to provide the plurality of display components so as to enable the user to engage with and view an advisor representation associated with the third party.

Display component providing module 212 may be configured to provide the plurality of display components including a first set of display components and a second set of display components. The first set of display components may be viewable in the three-dimensional environment by the user and by the third party. The second set of display components may be viewable in the three-dimensional environment by the user and not by the third party. A third set of display components may be viewable in the three-dimensional environment by the third party and not by the user.

Customer record detail display module 214 may be configured to concurrently display, in the virtual three-dimensional environment, the customer record details associated with the plurality of customer records such that the plurality of display components are concurrently viewable in the three-dimensional environment by the user and by the third party. Customer record detail display module 214 may be configured to concurrently display to both the user and the third party a first set of display components associated with a first set of customer records. Customer record detail display module 214 may be configured to display to the user and not to the third party a second set of display components associated with a second set of customer records. Customer record detail display module 214 may be configured to display to the third party and not to the user a third set of display components associated with a third set of customer records.

Advisor representation providing module 216 may be configured to provide an advisor representation in the three-dimensional virtual environment via which an advisor is configured to engage with the plurality of display components and with the user. Advisor representation providing module 216 may be configured to provide the advisor representation in the three-dimensional virtual environment by interfacing the three-dimensional virtual environment with a video communications application. For example, a video communication application window may be integrated into the three-dimensional virtual environment, for example in a context, an orientation and aspect ratio that is aligned with the user's current perspective or view of the three-dimensional virtual environment. Advisor representation providing module 216 may be configured to provide the advisor representation as an advisor avatar in the three-dimensional virtual environment.

Forecast generating module 218 may be configured to generate, by the processor, a forecast associated with a potential future state. Display component update module 220 may be configured to update the plurality of display components based on data associated with the forecast. Display component providing module 212 may be configured to provide the plurality of updated display components to enable the user to visualize forecast data associated with the potential future state.

The plurality of customer records may include a plurality of customer accounts and the data includes customer data. In some implementations, the three-dimensional virtual environment may include the metaverse.

In some embodiments, computing platform(s) 202, remote platform(s) 204, and/or external resources 222 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 222 may be operatively linked via some other communication media.

A given remote platform 204 may include one or more processors configured to execute computer program modules. The computer program modules may be configured to enable an expert or user associated with the given remote platform 204 to interface with system 200 and/or external resources 222, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 222 may include sources of information outside of system 200, external entities participating with system 200, and/or other resources. In some embodiments, some or all of the functionality attributed herein to external resources 222 may be provided by resources included in system 200.

Computing platform(s) 202 may include electronic storage 224, one or more processors 226, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 224 may comprise non-transitory storage media that electronically stores information. The electronic storage media of electronic storage 224 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 224 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 224 may include one or more virtual storage resources (e.g., cloud storage, a virtual private network, and/or other virtual storage resources). Electronic storage 224 may store software algorithms, information determined by processor(s) 226, information received from computing platform(s) 202, information received from remote platform(s) 204, and/or other information that enables computing platform(s) 202 to function as described herein.

Processor(s) 226 may be configured to provide information processing capabilities in computing platform(s) 202. As such, processor(s) 226 may include one or more of a digital processor, an analog processor, a digital circuit designed to process information, an analog circuit designed to process information, a state machine, and/or other mechanisms for electronically processing information. Although processor(s) 226 is shown in FIG. 2 as a single entity, this is for illustrative purposes only. In some embodiments, processor(s) 226 may include a plurality of processing units. These processing units may be physically located within the same device, or processor(s) 226 may represent processing functionality of a plurality of devices operating in coordination. Processor(s) 226 may be configured to execute modules 208, 210, 212, 214, 216, 218, and/or 220, and/or other modules. Processor(s) 226 may be configured to execute modules 208, 210, 212, 214, 216, 218, and/or 220, and/or other modules by software; hardware; firmware; some combination of software, hardware, and/or firmware; and/or other mechanisms for configuring processing capabilities on processor(s) 226. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, and/or 220 are illustrated in FIG. 2 as being implemented within a single processing unit, in embodiments in which processor(s) 226 includes multiple processing units, one or more of modules 208, 210, 212, 214, 216, 218, and/or 220 may be implemented remotely from the other modules. The description of the functionality provided by the different modules 208, 210, 212, 214, 216, 218, and/or 220 described below is for illustrative purposes, and is not intended to be limiting, as any of modules 208, 210, 212, 214, 216, 218, and/or 220 may provide more or less functionality than is described. For example, one or more of modules 208, 210, 212, 214, 216, 218, and/or 220 may be eliminated, and some or all of its functionality may be provided by other ones of modules 208, 210, 212, 214, 216, 218, and/or 220. As another example, processor(s) 226 may be configured to execute one or more additional modules that may perform some or all of the functionality attributed below to one of modules 208, 210, 212, 214, 216, 218, and/or 220.

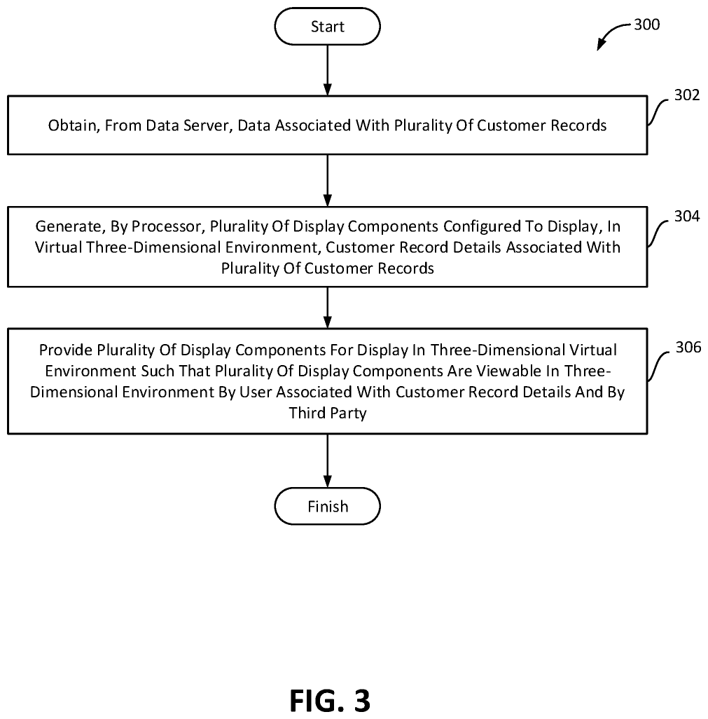

FIG. 3 illustrates a method 300 for enabling data access in a virtual environment, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, from a data server, data associated with a plurality of customer records. Operation 302 may be performed by one or more hardware processors configured by machine-readable instructions including a module that is the same as or similar to data obtaining module 208, in accordance with one or more embodiments.

An operation 304 may include generating, by a processor, a plurality of display components configured to display, in a virtual three-dimensional environment, customer record details associated with the plurality of customer records. Operation 304 may be performed by one or more hardware processors configured by machine-readable instructions including a module that is the same as or similar to display component generating module 210, in accordance with one or more embodiments.

An operation 306 may include providing the plurality of display components for display in the three-dimensional virtual environment such that the plurality of display components is viewable in the three-dimensional environment by a user associated with the customer record details and by a third party. Operation 306 may be performed by one or more hardware processors configured by machine-readable instructions including a module that is the same as or similar to display component providing module 212, in accordance with one or more embodiments.

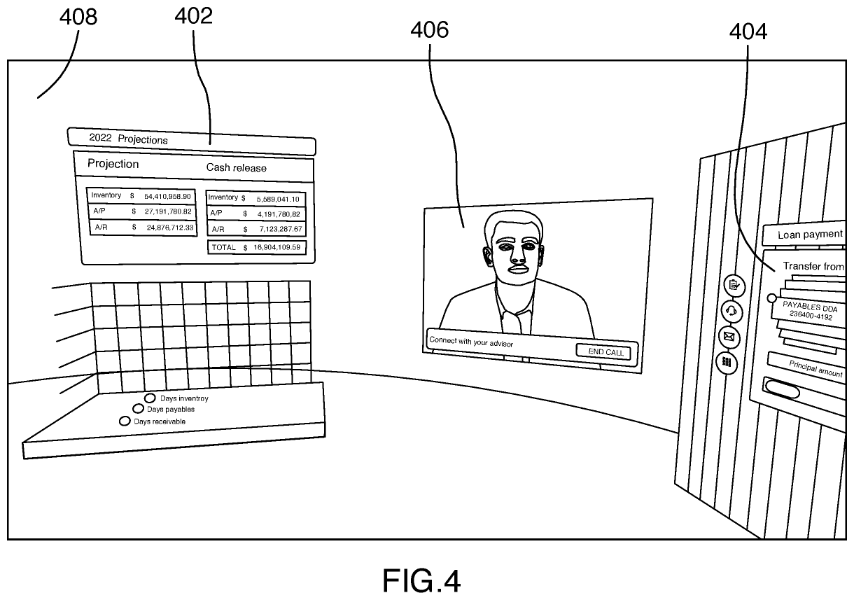

FIG. 4 illustrates an example of a display 400 illustrating data access in a virtual environment, in accordance with one or more embodiments. The example of FIG. 4 is an example screenshot of a user's view or perspective into their customer records, for example commercial banking information, in the three-dimensional virtual environment. As shown in FIG. 4, the system may be configured to display a plurality of display components. The plurality of display components may include account and transaction data, for example relating to invoices including days inventory, days payable, days receivable.

FIG. 4 illustrates an example of a plurality of sets of display components, which may comprise one or more forecasts or projections 402, for example including customer record details relating to inventory, A/P, A/R. The example of FIG. 4 shows a side-by-side details of the forecast or projection 402 including cash release amounts. The data included in the forecast or projection 402 may be powered by a forecasting module according to the present disclosure, such as the forecast generating module 218 of FIG. 2. In an example embodiment, the one or more projections 402 may be provided as a first set of display components, and current customer records or account data may be concurrently displayed as a second set of display components.

In the example embodiment of FIG. 4, the three-dimensional virtual environment may also display loan payment information 404. As shown in FIG. 4, a second set of display components, for example the loan payment information 404, may be either partially or completely displayed concurrently with a first set of display components, for example relating to the projections(s) 402. In an example embodiment, the second set of display components may display a first subset of data, and user interaction with the first subset of data may expand and/or further display a second subset of data. In an example embodiment, if a user navigates in the three-dimensional virtual environment in the direction of a second set of display components, the display may be configured to display additional display components associated with the second set of display components.

For example, in an implementation, only a portion of the loan payment information 404 is shown in a current view to a user as shown in FIG. 4. If the user navigates or causes the attention of the display device to focus on the load payment information 404, an apparatus according to an embodiment of the present disclosure may then generate or cause the display of additional display components to more fully show additional loan payment information.

Also shown in FIG. 4, the user may interact with a third party 406, such as an advisor. The third party or advisor may be associated with an advisor representation such as an avatar or an embedded video call. A system of the present disclosure may be configured to enable a user to interact with an advisor in such a way that the user and the advisor may view and interact with the plurality of display components, or displayed visual elements. This is similar to how the user and the advisor would be able to interact if all of the user's account and transaction data, as well as related forecasts, were provided on a plurality of large screens in a dedicated physical meeting room, with all of their account information synchronized in real-time. An example implementation of the present disclosure builds on this, by providing an unlimited amount of “screen” real estate.

Embodiments of the present disclosure enable any number of different account data visualizations to assist a user or customer in viewing and interpreting their data. Embodiments of the present disclosure are also configured to enable a user to interact in real-time with a third party, such as an advisor, to discuss the displayed data. Such interaction may include generating and viewing forecasts of possible effects on the different areas of the portfolio.

In FIG. 4, the plurality of display components is provided on a backdrop of a visual environment 408. The type of visual environment 408 displayed may be associated with a preferred pleasant experience for the user. For example, a user's customer records may include a background preference indicator that indicates a user's preference for a specific background for the visual environment 408, or a general preference for the outdoors or a visual environment associated with the outdoors. Accordingly, embodiments of the present disclosure may configure the virtual three-dimensional environment based on the stored background preference indicator to provide the display components on a display background or visual environment of an outdoor setting, such as parkland or a golf course. The user records or customer records, such as customer financial information, may be displayed in the context of that personalized setting, rather than with a background of a bank building or other display format that is not tailored to the user.

The present disclosure provides a system and method for accessing data in a virtual environment, for example in the metaverse. The present disclosure may provide, in the metaverse, a commercial banking experience with enhanced access to customer records or customer data, for example including commercial banking data, forecasting and visualization.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for enabling data access in a virtual environment. The system may include one or more hardware processors configured by machine-readable instructions. The processor(s) may be configured to obtain, from a data server, data associated with a plurality of customer records. The processor(s) may be configured to generate, by a processor, a plurality of display components configured to display, in a virtual three-dimensional environment, customer record details associated with the plurality of customer records. The processor(s) may be configured to provide the plurality of display components for display in the three-dimensional virtual environment such that the plurality of display components is viewable in the three-dimensional environment by a user associated with the customer record details and by a third party.

In some implementations of the system, the plurality of customer records may be associated with a customer account.

In some implementations of the system, the plurality of customer records may include a plurality of customer accounts and the data includes customer data.

In some implementations of the system, the plurality of customer records may include a plurality of commercial accounts.

In some implementations of the system, the user may include a customer associated with the plurality of customer records.

In some implementations of the system, the three-dimensional virtual environment may include the metaverse.

In some implementations of the system, the data server may include a financial institution data server.

In some implementations of the system, the processor(s) may be configured to concurrently display, in the virtual three-dimensional environment, the customer record details associated with the plurality of customer records such that the plurality of display components are concurrently viewable in the three-dimensional environment by the user and by the third party.

In some implementations of the system, the third party may include an advisor.

In some implementations of the system, the processor(s) may be configured to provide an advisor representation in the three-dimensional virtual environment via which an advisor is configured to engage with the plurality of display components and with the user.

In some implementations of the system, the processor(s) may be configured to provide the advisor representation in the three-dimensional virtual environment by interfacing the three-dimensional virtual environment with a video communications application.

In some implementations of the system, the processor(s) may be configured to provide the advisor representation as an advisor avatar in the three-dimensional virtual environment.

In some implementations of the system, the processor(s) may be configured to provide the plurality of display components so as to enable the user to engage with and view the advisor representation.

In some implementations of the system, the processor(s) may be configured to provide the plurality of display components including a first set of display components and a second set of display components. In some implementations of the system, the first set of display components may be viewable in the three-dimensional environment by the user and by the third party. In some implementations of the system, the second set of display components may be viewable in the three-dimensional environment by the user and not by the third party.

In some implementations of the system, the processor(s) may be configured to generate, by the processor, a forecast associated with a potential future state. In some implementations of the system, the processor(s) may be configured to update the plurality of display components based on data associated with the forecast. In some implementations of the system, the processor(s) may be configured to provide the plurality of updated display components to enable the user to visualize forecast data associated with the potential future state.

Another aspect of the present disclosure relates to a method for enabling data access in a virtual environment. The method may include obtaining, from a data server, data associated with a plurality of customer records. The method may include generating, by a processor, a plurality of display components configured to display, in a virtual three-dimensional environment, customer record details associated with the plurality of customer records. The method may include providing the plurality of display components for display in the three-dimensional virtual environment such that the plurality of display components is viewable in the three-dimensional environment by a user associated with the customer record details and by a third party.

In some implementations of the method, the plurality of customer records may be associated with a customer account.

In some implementations of the method, the plurality of customer records may include a plurality of customer accounts and the data includes customer data.

In some implementations of the method, the plurality of customer records may include a plurality of commercial accounts.

In some implementations of the method, the user may include a customer associated with the plurality of customer records.

In some implementations of the method, the three-dimensional virtual environment may include the metaverse.

In some implementations of the method, the data server may include a financial institution data server.

In some implementations of the method, it may include concurrently displaying, in the virtual three-dimensional environment, the customer record details associated with the plurality of customer records such that the plurality of display components are concurrently viewable in the three-dimensional environment by the user and by the third party.

In some implementations of the method, the third party may include an advisor.

In some implementations of the method, it may include providing an advisor representation in the three-dimensional virtual environment via which an advisor is configured to engage with the plurality of display components and with the user.

In some implementations of the method, it may include providing the advisor representation in the three-dimensional virtual environment by interfacing the three-dimensional virtual environment with a video communications application.

In some implementations of the method, it may include providing the advisor representation as an advisor avatar in the three-dimensional virtual environment.

In some implementations of the method, it may include providing the plurality of display components so as to enable the user to engage with and view the advisor representation.

In some implementations of the method, it may include providing the plurality of display components including a first set of display components and a second set of display components. In some implementations of the method, the first set of display components may be viewable in the three-dimensional environment by the user and by the third party. In some implementations of the method, the second set of display components may be viewable in the three-dimensional environment by the user and not by the third party.

In some implementations of the method, it may include generating, by the processor, a forecast associated with a potential future state. In some implementations of the method, it may include updating the plurality of display components based on data associated with the forecast. In some implementations of the method, it may include providing the plurality of updated display components to enable the user to visualize forecast data associated with the potential future state.

Yet another aspect of the present disclosure relates to a non-transient computer-readable storage medium having instructions embodied thereon, the instructions being executable by one or more processors to perform a method for enabling data access in a virtual environment. The method may include obtaining, from a data server, data associated with a plurality of customer records. The method may include generating, by a processor, a plurality of display components configured to display, in a virtual three-dimensional environment, customer record details associated with the plurality of customer records. The method may include providing the plurality of display components for display in the three-dimensional virtual environment such that the plurality of display components is viewable in the three-dimensional environment by a user associated with the customer record details and by a third party.

In some implementations of the computer-readable storage medium, the plurality of customer records may be associated with a customer account.

In some implementations of the computer-readable storage medium, the plurality of customer records may include a plurality of customer accounts and the data includes customer data.

In some implementations of the computer-readable storage medium, the plurality of customer records may include a plurality of commercial accounts.

In some implementations of the computer-readable storage medium, the user may include a customer associated with the plurality of customer records.

In some implementations of the computer-readable storage medium, the three-dimensional virtual environment may include the metaverse.

In some implementations of the computer-readable storage medium, the data server may include a financial institution data server.

In some implementations of the computer-readable storage medium, the method may include concurrently displaying, in the virtual three-dimensional environment, the customer record details associated with the plurality of customer records such that the plurality of display components are concurrently viewable in the three-dimensional environment by the user and by the third party.

In some implementations of the computer-readable storage medium, the third party may include an advisor.

In some implementations of the computer-readable storage medium, the method may include providing an advisor representation in the three-dimensional virtual environment via which the advisor is configured to engage with the plurality of display components and with the user.

In some implementations of the computer-readable storage medium, the method may include providing the advisor representation in the three-dimensional virtual environment by interfacing the three-dimensional virtual environment with a video communications application.

In some implementations of the computer-readable storage medium, the method may include providing the advisor representation as an advisor avatar in the three-dimensional virtual environment.

In some implementations of the computer-readable storage medium, the method may include providing the plurality of display components so as to enable the user to engage with and view the advisor representation.

In some implementations of the computer-readable storage medium, the method may include providing the plurality of display components including a first set of display components and a second set of display components. In some implementations of the computer-readable storage medium, the first set of display components may be viewable in the three-dimensional environment by the user and by the third party. In some implementations of the computer-readable storage medium, the second set of display components may be viewable in the three-dimensional environment by the user and not by the third party.

In some implementations of the computer-readable storage medium, the method may include generating, by the processor, a forecast associated with a potential future state. In some implementations of the computer-readable storage medium, the method may include updating the plurality of display components based on data associated with the forecast. In some implementations of the computer-readable storage medium, the method may include providing the plurality of updated display components to enable the user to visualize forecast data associated with the potential future state.

Still another aspect of the present disclosure relates to a system configured for enabling data access in a virtual environment. The system may include means for obtaining, from a data server, data associated with a plurality of customer records. The system may include means for generating, by a processor, a plurality of display components configured to display, in a virtual three-dimensional environment, customer record details associated with the plurality of customer records. The system may include means for providing the plurality of display components for display in the three-dimensional virtual environment such that the plurality of display components is viewable in the three-dimensional environment by a user associated with the customer record details and by a third party.

In some implementations of the system, the plurality of customer records may be associated with a customer account.

In some implementations of the system, the plurality of customer records may include a plurality of customer accounts and the data includes customer data.

In some implementations of the system, the plurality of customer records may include a plurality of commercial accounts.

In some implementations of the system, the user may include a customer associated with the plurality of customer records.

In some implementations of the system, the three-dimensional virtual environment may include the metaverse.

In some implementations of the system, the data server may include a financial institution data server.

In some implementations of the system, the system may include means for concurrently displaying, in the virtual three-dimensional environment, the customer record details associated with the plurality of customer records such that the plurality of display components are concurrently viewable in the three-dimensional environment by the user and by the third party.

In some implementations of the system, the third party may include an advisor.

In some implementations of the system, the system may include means for providing an advisor representation in the three-dimensional virtual environment via which an advisor is configured to engage with the plurality of display components and with the user.

In some implementations of the system, the system may include means for providing the advisor representation in the three-dimensional virtual environment by interfacing the three-dimensional virtual environment with a video communications application.

In some implementations of the system, the system may include means for providing the advisor representation as an advisor avatar in the three-dimensional virtual environment.

In some implementations of the system, the system may include means for providing the plurality of display components so as to enable the user to engage with and view the advisor representation.

In some implementations of the system, the system may include means for providing the plurality of display components including a first set of display components and a second set of display components. In some implementations of the system, the first set of display components may be viewable in the three-dimensional environment by the user and by the third party. In some implementations of the system, the second set of display components may be viewable in the three-dimensional environment by the user and not by the third party.

In some implementations of the system, the system may include means for generating, by the processor, a forecast associated with a potential future state. In some implementations of the system, the system may include means for updating the plurality of display components based on data associated with the forecast. In some implementations of the system, the system may include means for providing the plurality of updated display components to enable the user to visualize forecast data associated with the potential future state.

Even another aspect of the present disclosure relates to a computing platform configured for enabling data access in a virtual environment. The computing platform may include a non-transient computer-readable storage medium having executable instructions embodied thereon. The computing platform may include one or more hardware processors configured to execute the instructions. The processor(s) may execute the instructions to obtain, from a data server, data associated with a plurality of customer records. The processor(s) may execute the instructions to generate, by a processor, a plurality of display components configured to display, in a virtual three-dimensional environment, customer record details associated with the plurality of customer records. The processor(s) may execute the instructions to provide the plurality of display components for display in the three-dimensional virtual environment such that the plurality of display components is viewable in the three-dimensional environment by a user associated with the customer record details and by a third party.

In some implementations of the computing platform, the plurality of customer records may be associated with a customer account.

In some implementations of the computing platform, the plurality of customer records may include a plurality of customer accounts and the data includes customer data.

In some implementations of the computing platform, the plurality of customer records may include a plurality of commercial accounts.

In some implementations of the computing platform, the user may include a customer associated with the plurality of customer records.

In some implementations of the computing platform, the three-dimensional virtual environment may include the metaverse.

In some implementations of the computing platform, the data server may include a financial institution data server.

In some implementations of the computing platform, the processor(s) may execute the instructions to concurrently display, in the virtual three-dimensional environment, the customer record details associated with the plurality of customer records such that the plurality of display components are concurrently viewable in the three-dimensional environment by the user and by the third party.

In some implementations of the computing platform, the third party may include an advisor.

In some implementations of the computing platform, the processor(s) may execute the instructions to provide an advisor representation in the three-dimensional virtual environment via which an advisor is configured to engage with the plurality of display components and with the user.

In some implementations of the computing platform, the processor(s) may execute the instructions to provide the advisor representation in the three-dimensional virtual environment by interfacing the three-dimensional virtual environment with a video communications application.

In some implementations of the computing platform, the processor(s) may execute the instructions to provide the advisor representation as an advisor avatar in the three-dimensional virtual environment.

In some implementations of the computing platform, the processor(s) may execute the instructions to provide the plurality of display components so as to enable the user to engage with and view the advisor representation.

In some implementations of the computing platform, the processor(s) may execute the instructions to provide the plurality of display components including a first set of display components and a second set of display components. In some implementations of the computing platform, the first set of display components may be viewable in the three-dimensional environment by the user and by the third party. In some implementations of the computing platform, the second set of display components may be viewable in the three-dimensional environment by the user and not by the third party.

In some implementations of the computing platform, the processor(s) may execute the instructions to generate, by the processor, a forecast associated with a potential future state. In some implementations of the computing platform, the processor(s) may execute the instructions to update the plurality of display components based on data associated with the forecast. In some implementations of the computing platform, the processor(s) may execute the instructions to provide the plurality of updated display components to enable the user to visualize forecast data associated with the potential future state.

What is claimed is:

1. An apparatus configured for enabling data access in a virtual environment, the apparatus comprising:
a non-transient computer-readable storage medium having executable instructions embodied thereon; and
one or more hardware processors configured to execute the instructions to:
obtain, from a data server, data associated with a plurality of customer records;
generate, by a processor, a plurality of display components configured to display, in a virtual three-dimensional environment, customer record details associated with the plurality of customer records; and
provide the plurality of display components for display in the three-dimensional virtual environment such that the plurality of display components is viewable in the three-dimensional environment by a user associated with the customer record details and by a third party.

2. The apparatus of claim 1 wherein the one or more hardware processors are further configured to execute the instructions to:
concurrently display, in the virtual three-dimensional environment, the customer record details associated with the plurality of customer records such that the plurality of display components are concurrently viewable in the three-dimensional environment by the user and by the third party.

3. The apparatus of claim 1 wherein the one or more hardware processors are further configured to execute the instructions to:
provide an advisor representation in the three-dimensional virtual environment via which an advisor is configured to engage with the plurality of display components and with the user.

4. The apparatus of claim 3 wherein the one or more hardware processors are further configured to execute the instructions to:
provide the advisor representation in the three-dimensional virtual environment by interfacing the three-dimensional virtual environment with a video communications application.

5. The apparatus of claim 3 wherein the one or more hardware processors are further configured to execute the instructions to:
provide the advisor representation as an advisor avatar in the three-dimensional virtual environment.

6. The apparatus of claim 3 wherein the one or more hardware processors are further configured to execute the instructions to:
provide the plurality of display components so as to enable the user to engage with and view the advisor representation.

7. The apparatus of claim 1 wherein the one or more hardware processors are further configured to execute the instructions to:
provide the plurality of display components including a first set of display components and a second set of display components,
wherein the first set of display components are viewable in the three-dimensional environment by the user and by the third party, and
wherein the second set of display components are viewable in the three-dimensional environment by the user and not by the third party.

8. The apparatus of claim 1 wherein the one or more hardware processors are further configured to execute the instructions to:
generate, by the processor, a forecast associated with a potential future state;
update the plurality of display components based on data associated with the forecast; and
provide the plurality of updated display components to enable the user to visualize forecast data associated with the potential future state.

9. The apparatus of claim 1 wherein the data server comprises a financial institution data server, the plurality of customer records is associated with a customer account, the user comprises a customer associated with the plurality of customer records, and the three-dimensional virtual environment comprises the metaverse.

10. A computer-implemented method for enabling data access in a virtual environment, the method comprising:
obtaining, from a data server, data associated with a plurality of customer records;
generating, by a processor, a plurality of display components configured to display, in a virtual three-dimensional environment, customer record details associated with the plurality of customer records; and
providing the plurality of display components for display in the three-dimensional virtual environment such that the plurality of display components is viewable in the three-dimensional environment by a user associated with the customer record details and by a third party.

11. The method of claim 10 further comprising:
concurrently displaying, in the virtual three-dimensional environment, the customer record details associated with the plurality of customer records such that the plurality of display components are concurrently viewable in the three-dimensional environment by the user and by the third party.

12. The method of claim 10 further comprising:
providing an advisor representation in the three-dimensional virtual environment via which an advisor is configured to engage with the plurality of display components and with the user.

13. The method of claim 12 further comprising:
providing the advisor representation in the three-dimensional virtual environment by interfacing the three-dimensional virtual environment with a video communications application.

14. The method of claim 12 further comprising:
providing the advisor representation as an advisor avatar in the three-dimensional virtual environment.

15. The method of claim 12 further comprising:
providing the plurality of display components so as to enable the user to engage with and view the advisor representation.

16. The method of claim 10 further comprising:
providing the plurality of display components including a first set of display components and a second set of display components,
wherein the first set of display components is viewable in the three-dimensional environment by the user and by the third party, and
wherein the second set of display components is viewable in the three-dimensional environment by the user and not by the third party.

17. The method of claim 10 further comprising:
generating, by the processor, a forecast associated with a potential future state;
updating the plurality of display components based on data associated with the forecast; and
providing the plurality of updated display components to enable the user to visualize forecast data associated with the potential future state.

18. The method of claim 10, wherein the data server comprises a financial institution data server, the plurality of customer records is associated with a customer account, the user comprises a customer associated with the plurality of customer records, and the three-dimensional virtual environment comprises the metaverse.

19. A non-transient computer-readable storage medium having instructions embodied thereon, the instructions being executable by one or more processors to perform a method for providing multi-channel authentication, the method comprising:
obtaining, from a data server, data associated with a plurality of customer records;
generating, by a processor, a plurality of display components configured to display, in a virtual three-dimensional environment, customer record details associated with the plurality of customer records; and
providing the plurality of display components for display in the three-dimensional virtual environment such that the plurality of display components is viewable in the three-dimensional environment by a user associated with the customer record details and by a third party.

20. The non-transient computer-readable storage medium of claim 19 wherein the method further comprises:
providing an advisor representation in the three-dimensional virtual environment via which an advisor is configured to engage with the plurality of display components and with the user.
